(19) United States
(12) Patent Application Publication
(10) Pub. No.: US 2024/0402318 A1
(43) Pub. Date: Dec. 5, 2024

(54) CALIBRATION MODULE AND USE METHOD THEREFOR

(71) Applicant: NATIONAL INSTITUTE OF METROLOGY, Beijing (CN)

(72) Inventors: Yingwei HE, Beijing (CN); Haiyong GAN, Beijing (CN); Houping WU, Beijing (CN); Yingce WANG, Beijing (CN); Chundi ZHENG, Beijing (CN); Guojin FENG, Beijing (CN)

(21) Appl. No.: 18/725,942

(22) PCT Filed: Sep. 28, 2022
(86) PCT No.: PCT/CN2022/122058

§ 371 Date: Jul. 1, 2024

(30) Foreign Application Priority Data
Jun. 27, 2022 (CN) 202210745216.5

(51) Int. Cl. G01S 7/497

(52) U.S. Cl. CPC G01S 7/497

(57) ABSTRACT

A calibration module and a use method therefor. The calibration module comprises: a plurality of observation planes, wherein among the plurality of observation planes, planes where at least two observation planes are located intersect, and there is a determined spatial position relationship between the plurality of observation planes. Each observation plane is provided with an observation area, and each observation area is provided with a corresponding calibrated BRDF value. By means of providing a polyhedral calibration module, the accuracy of measurement of the attitude of the calibration module and the incident angle of a light source is improved, such that the accuracy of testing of a BRDF characteristic of a surface of an object to be tested is improved.

### CROSS-REFERENCE TO RELATED APPLICATIONS

This application is a national phase entry under 35 U.S.C. § 371 of International Patent Application PCT/CN2022/122058, filed Sep. 28, 2022, designating the United States of America and published as International Patent Publication WO 2024/000878 A1 on Jan. 4, 2024, which claims the benefit under Article 8 of the Patent Cooperation Treaty of Chinese Patent Application Serial No. 202210745216.5, filed Jun. 27, 2022, the disclosure of which is incorporated herein by reference.

### TECHNICAL FIELD

The present disclosure relates to the field of reflection detection, and particular to a scaling module and a usage method thereof.

### BACKGROUND

When optical characteristics of the surface of a to-be-measured object are detected, a standard plate is often used as a scaler for calibration. However, it is difficult for the standard plate to well characterize optical characteristics of a to-be-measured target, which results in low detection accuracy of the optical characteristics of the surface of the to-be-measured object.

### BRIEF SUMMARY

The present disclosure provides a scaling module and a usage method thereof, which solve or alleviate the problem of low detection accuracy when optical characteristics of the surface of a to-be-measured object are detected using a standard plate.

The present disclosure provides a scaling module, including: a plurality of observation planes, at least two of the plurality of observation planes intersect with each other, the plurality of observation planes have a certain relative space positional relationship, each observation plane is provided with an observation region, and each observation region has a corresponding calibrated bidirectional reflectance distribution function (BRDF) value.

According to a scaling module provided by the present disclosure, shapes of the observation region include: a regular triangle, a square, a regular pentagon, a regular hexagon, and a regular octagon.

According to a scaling module provided by the present disclosure, the observation region is divided into a plurality of standard regions, and any two standard regions in the same observation region have different bidirectional reflectance distribution function values.

According to a scaling module provided by the present disclosure, the plurality of observation planes enclose a closed cavity.

The present disclosure further provides a usage method of the scaling module as described above, including:
obtaining first image information of the scaling module and second image information of a to-be-measured object by placing the scaling module in a light source environment where the to-be-measured object is located;
determining an attitude of the scaling module and an incident angle of a light source based on the first image information;
determining a first radiance value of a surface of interest on the to-be-measured object based on the second image information; and
matching the surface of interest with an observation region and determining a BRDF characteristic of the surface of interest under the light source environment based on the first radiance value.

According to a usage method of the scaling module provided by the present disclosure, determining the attitude of the scaling module and the incident angle of the light source based on the first image information includes:
performing ellipse fitting on each vertex of one of the observation regions on the first image information to obtain a fitted ellipse;
obtaining a center coordinate, a major axis length and a minor axis length of the fitted ellipse; and
determining an orientation of the observation plane corresponding to the fitted ellipse based on the center coordinate, the major axis length, and the minor axis length of the fitted ellipse to obtain the attitude of the scaling module.

According to a usage method of the scaling module provided by the present disclosure, determining the attitude of the scaling module and the incident angle of the light source based on the first image information further includes:
determining a second radiance value and an irradiance value corresponding to each observation region on the first image information based on the first image information;
determining a length of a normal vector of the plane where the corresponding observation region is located based on the irradiance value; and
obtaining the incident angle of the light source by combining normal vectors corresponding to the plurality of observation regions.

According to a usage method of the scaling module provided by the present disclosure, matching the surface of interest with the observation region and determining the BRDF characteristic of the surface of interest under the light source environment based on the first radiance value includes:
matching the first radiance value with a plurality of the second radiance values to determine an observation region corresponding to the surface of interest; and
determining the BRDF characteristic of the surface of interest under the light source environment based on the BRDF characteristic of the observation region under the light source environment.

According to a usage method of the scaling module provided by the present disclosure, determining the attitude of the scaling module and the incident angle of the light source based on the first image information further includes:
obtaining an echo time and an echo intensity of each observation region of the scaling module; and
determining the attitude of the scaling module based on the echo time and the echo intensity.

In the scaling module and the usage method thereof provided by the present disclosure, by providing a plurality of observation planes, the plurality of observation planes form a three-dimensional scaling module, and the plurality of observation planes have a certain relative space positional relationship. Since an included angle between the normal vector of any two observation planes is a preset value, attitude of the scaling module may be determined as long as the orientation of any two intersecting observation planes is known. Each observation region has been assigned and calibrated in advance, so that each observation region has a known BRDF value. When the BRDF characteristics of the surface of the to-be-measured object are detected using the scaling module, the scaling module is placed under the same light source environment as the to-be-measured object and the BRDF characteristics corresponding to each observation region under the light source environment may be obtained by calculating the attitude of the scaling module and the incident angle of the light source, and based on the known BRDF values of each observation region. The surface of the to-be-measured object is matched with the observation region by collecting the radiance of the surface of the to-be-measured object and traversing an observation region close to the radiance of the to-be-measured object among the plurality of observation regions to obtain the BRDF characteristics of the surface of the to-be-measured object under the light source environment are obtained. By providing the three-dimensional scaling module, the attitude of the scaling module and the incident angle of the light source may be measured from multiple dimensions, which improves both the accuracy of measuring the attitude of the scaling module and the incident angle of the light source and accuracy of measuring the BRDF characteristics of the surface of the to-be-measured object and improves the precision and accuracy of measurement while avoiding blind spots in the visual field.

### BRIEF DESCRIPTION OF THE DRAWINGS

To illustrate the solutions of the embodiments according to the present disclosure or the related art, the accompanying drawings used in the description for the embodiments or the related art are briefly described below. It should be noted that the drawings in the following description are only some embodiments of the present disclosure. For those of ordinary skill in the art, other drawings may be obtained according to these drawings without creative effort.

FIG. 1 is a schematic diagram of a principle of measuring an attitude of a scaling module according to the present disclosure;

FIG. 2 is a schematic diagram of a principle of measuring an incident angle of a light source according to the present disclosure;

FIG. 3 is a schematic diagram of a layout of a scaling module and a to-be-measured object according to the present disclosure; and

FIG. 4 is a schematic flowchart of a usage method of a scaling module according to the present disclosure.

### REFERENCE SIGNS

1: scaling module; 2: to-be-measured object; 3: camera; 4: laser radar; 5: circular track.

### DETAILED DESCRIPTION

To illustrate the solutions and advantages of the embodiments more clearly according to the present disclosure, the solutions in the embodiments of the present disclosure are clearly and completely described below in conjunction with the accompanying drawings in the embodiments of the present disclosure. It should be noted that, the described embodiments are part of the embodiments of the present disclosure, but not all of the embodiments. Based on the embodiments in the present disclosure, all other embodiments obtained by those of ordinary skill in the art without creative efforts fall within the scope of protection of the present disclosure.

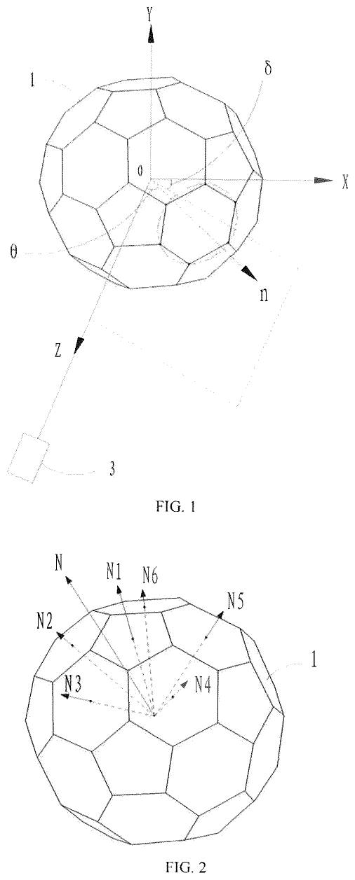

A scaling module and a usage method thereof according to the present disclosure will be described below in conjunction with FIG. 1 to FIG. 4.

As shown in FIG. 1 and FIG. 2, the scaling module shown in the present embodiment includes: a plurality of observation planes, at least two of the plurality of observation planes intersect with each other, the plurality of observation planes have a certain relative space positional relationship, each observation plane is provided with an observation region, and each observation region has a corresponding calibrated bidirectional reflectance distribution function (BRDF) value.

In the scaling module 1 shown in the present embodiment, by providing a plurality of observation planes, the plurality of observation planes form a three-dimensional scaling module, and the plurality of observation planes have a certain relative space positional relationship. Since an included angle between the normal vector of any two observation planes is a preset value, attitude of the scaling module may be determined as long as the orientation of any two intersecting observation planes is known. Each observation region has been assigned and calibrated in advance, so that each observation region has a known BRDF value. When the BRDF characteristics of the surface of the to-be-measured object are detected using the scaling module, the scaling module 1 is placed under the same light source environment as the to-be-measured object 2 and the BRDF characteristics corresponding to each observation region under the light source environment may be obtained by calculating the attitude of the scaling module and the incident angle of the light source, and based on the known BRDF values of each observation region. The surface of the to-be-measured object is matched with the observation region by collecting the radiance of the surface of the to-be-measured object 2 and traversing an observation region close to the radiance of the to-be-measured object 2 among the plurality of observation regions to obtain the BRDF characteristics of the surface of the to-be-measured object under the light source environment are obtained. By providing the three-dimensional scaling module 1, the attitude of the scaling module 1 and the incident angle of the light source may be measured from multiple dimensions, which improves both the accuracy of measuring the attitude of the scaling module 1 and the incident angle of the light source and accuracy of measuring the BRDF characteristics of the surface of the to-be-measured object 2 and improves the precision and accuracy of measurement while avoiding blind spots in the visual field.

It should be noted that BRDF refers to the bidirectional reflectance distribution function, and a specific mode of determining the attitude of the scaling module 1 determined based on a known orientation of any two intersected observation planes in the scaling module 1 will be described later.

To improve the detection accuracy and the detection efficiency of the BRDF characteristics of the surface of the to-be-measured object 2, a scaling module 1 similar in shape to the to-be-measured object 2 may be three-dimensional printed according to the contour of the to-be-measured object 2. After printing, each observation region is assigned.

In an embodiment, as shown in FIG. 1, shapes of the observation region shown in the present embodiment include: a regular triangle, a square, a regular pentagon, a regular hexagon, and a regular octagon.

An observation region is provided on each observation plane. By providing the observation region as a regular polygon, the observation region may reflect light evenly, therefore the scaling accuracy of the scaling module 1 is improved.

The shape of the observation region is not limited to the regular polygon, but may also be irregular polygon; the number of regular polygonal observation regions is less than or equal to the number of observation planes. Setting the shape of the observation region to a regular polygon is helpful for determining an attitude of the scaling module 1, which will be described in detail later.

In an embodiment, the observation region is divided into a plurality of standard regions, and the plurality of standard regions have at least two BRDF characteristics.

On the plurality of standard regions in the same observation region, a BRDF value is assigned to each standard region. By providing at least two BRDF values, the same observation region has at least two BRDF characteristics, which is equivalent to increasing the number of the observation regions, which increases a matchable range of the surface of the to-be-measured object 2 and improves the versatility of the scaling module 1.

In an embodiment, as shown in FIG. 1, the plurality of observation planes shown in the present embodiment form a closed cavity. Correspondingly, the scaling module 1 has a polyhedral structure. Thus, the scaling module 1 may be able to produce reflected light regardless of the angle that light irradiating the scaling module, and avoid irradiation blind spots.

The shape of the scaling module 1 may be set to the same shape as an Archimedes polyhedron.

As shown in FIG. 4, the present disclosure further provides a usage method of the scaling module, the method including step 410, step 420 and step 430.

Step 410: obtaining first image information of the scaling module and second image information of a to-be-measured object by placing the scaling module in a light source environment where the to-be-measured object is located.

The first image information of the scaling module and the second image information of the to-be-measured object are obtained by placing the scaling module in a light source environment where the to-be-measured object is located.

Since the BRDF characteristics depend on the incident angle of the light source, when the spatial range of the light source environment is small, for example, when the measurement is performed under an indoor environment where the light source is a fluorescent lamp, an incident angle of the light on the scaling module is different from an incident angle of the light irradiating on the to-be-measured object and the BRDF characteristics of the to-be-measured object obtained through the scaling module are less reliable if the distance between the scaling module and the to-be-measured object is large; thus, the scaling module needs to be placed close to the to-be-measured object.

When the spatial range of the light source environment is large, for example, when the measurement is performed under an open outdoor environment where the light source is natural light, the distance between the scaling module and the to-be-measured object has little impact on the incident angle of the light source, and the distance between the scaling module and the to-be-measured object may be appropriately increased.

The first image information and the second image information may be obtained by a camera.

Step 420: determining an attitude of the scaling module and an incident angle of a light source based on the first image information; determining a first radiance value of a surface of interest on the to-be-measured object based on the second image information.

In step 420, the mode for determining the attitude of the scaling module includes step 421, step 422 and step 423.

Step 421: performing ellipse fitting on each vertex of one of the observation regions on the first image information to obtain a fitted ellipse.

The first image information collected by the camera is a plane image, while the scaling module is in the shape of a polyhedron, the plane image is the projection view of the scaling module and the shape of each observation region on the plane image is not the true shape of the observation region, that is, the shape of the observation region has changed. However, an orientation of the observation region relative to the camera may be indirectly calculated based on the degree of change in the shape of the observation region.

As mentioned above, the observation region is set as a regular polygon to facilitate the fitting of each vertex of the regular polygon.

First, a coordinate system as shown in FIG. 1 is established where a point O is a center of the scaling module, a straight line where the Z axis is located is a line connecting the point O to the camera, the X axis is parallel to the horizontal plane, and the Y axis is perpendicular to the X axis and the Z axis is perpendicular to the X-Y plane.

The line connecting the center of each observation region to the center of the scaling module is perpendicular to the plane where the observation region is located.

Ellipse fitting is performed on each vertex of one of the observation regions and the contour of the fitted ellipse is shown as the dotted line in FIG. 1. The expression of the fitted ellipse in the coordinate system is:

$${ax}^{2} + 2 bxy + {cy}^{2} + 2 dx + 2 fy + g = 0 ,$$

where a, b, c, d, f, g are all constants.

Step 422: obtaining a center coordinate, a major axis length and a minor axis length of the fitted ellipse.

A center coordinate (x0, y0) of the fitted ellipse is calculated based on each constant in the above expression, thus, a vector formed by the center of the fitted ellipse and point O is perpendicular to the plane where the fitted ellipse is located, that is, the vector is a normal vector.

The calculation formula of x0 is:

$${x}_{0} = \frac{cd - bf}{{b}^{2} - ac} ,$$

and the calculation formula of y0 is:

$${y}_{0} = \frac{af - bd}{{b}^{2} - ac} .$$

Both the major axis length and the minor axis of the fitted ellipse are calculated respectively based on each constant in the above expression.

The calculation formula of the long axis length a′ is:

$${a}^{′} = 2 \sqrt{\frac{2 ( {af}^{2} + {cd}^{2} + {gb}^{2} - 2 bdf - acg )}{( {b}^{2} - ac ) [ \sqrt{{( a - c )}^{2} + 4 {b}^{2}} - ( a + c ) ]}} ,$$

and the calculation formula of minor axis length b′ is:

$${b}^{′} = 2 \sqrt{\frac{2 ( {af}^{2} + {cd}^{2} + {gb}^{2} - 2 bdf - acg )}{( {b}^{2} - ac ) [ - \sqrt{{( a - c )}^{2} + 4 {b}^{2}} - ( a + c ) ]}} .$$

Step 423: determining an orientation of the observation plane corresponding to the fitted ellipse based on the center coordinate, the major axis length, and the minor axis length of the fitted ellipse to obtain the attitude of the scaling module.

If the observation plane faces the camera directly, that is, the normal vector of the observation plane coincides with the Z-axis, then the circumscribed circle corresponding to the observation region is the fitted ellipse. When the observation plane deflects, the major axis and minor axis of the fitted ellipse change, the deflection angle of the observation plane is calculated from the ratio of the major axis to the minor axis of the fitted ellipse. The deflection angle is the angle θ between the normal vector n of the observation plane and the Z axis. The calculation formula of the angle θ is as follows:

$$θ = arc cos ( \frac{{b}^{′}}{{a}^{′}} ) .$$

Since θ may only represent the orientation of the fitted ellipse relative to the camera, it is also necessary to calculate an orientation of the plane where the fitted ellipse is located in the coordinate system, that is, to determine an included angle δ between the plane formed by the normal vector n and the Z axis and the X-Z plane. The calculation formula of δ is as follows:

$$δ = \frac{π}{2} - Φ .$$

In the above formula, Φ is the complementary angle of δ, and the calculation formula of Φ is as follows:

$$if b = 0 and a < c , then Φ = 0 ; \\ if b = 0 and a < c , then Φ = \frac{π}{2} ; \\ if b \neq 0 and a < c , then Φ = \frac{1}{2} {cot}^{- 1} ( \frac{a - c}{2 b} ) ; \\ if b \neq 0 and a > c , then Φ = \frac{π}{2} + \frac{1}{2} {cot}^{- 1} ( \frac{a - c}{2 b} ) .$$

The orientation of the observation plane where the fitted ellipse is located in the coordinate system may be determined based on θ and δ.

Similarly, an observation region that intersects with the plane where the fitted ellipse is located is selected, and ellipse fitting is performed on each vertex of the selected observation region using the above method, to obtain the orientation of the plane where the selected observation region is located in the coordinate system.

The attitude of the scaling module in the coordinate system may be obtained based on the orientation of the two intersecting planes in the coordinate system.

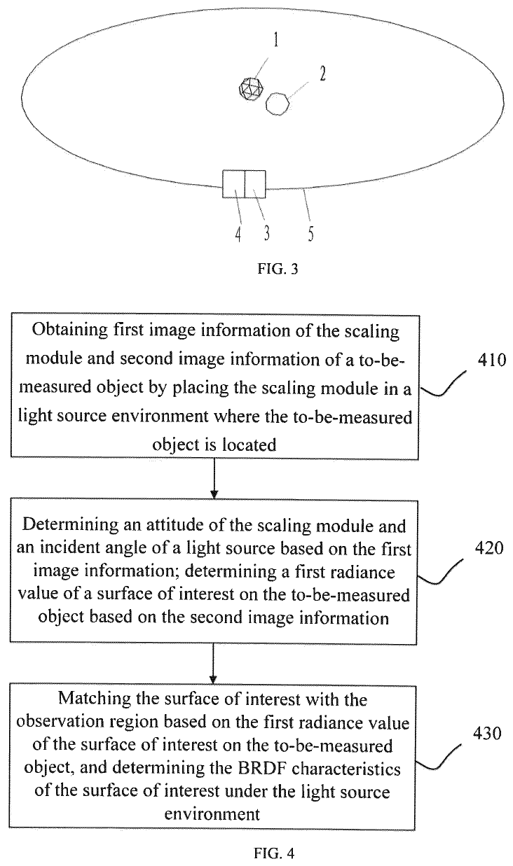

In the above steps, performing ellipse fitting based on each vertex of the observation region relies on the first image information. Under weak illumination conditions, the contour of the observation region in the first image information is blurred, resulting in lower precision of the fitted ellipse. A laser radar 4 may be used to assist the camera 3 to determine the attitude of the scaling module 1. As shown in FIG. 3, the laser radar 4 is arranged close to the camera 3, and the scaling module 1 is arranged on a center of a circular track 5. The laser radar 4 and the camera 3 may move synchronously along the circular track 5. The specific method for determining the attitude of scaling module 1 using the laser radar 4 is as follows.

The laser radar 4 is used to obtain an echo time and an echo intensity of each observation region of the scaling module 1, and the attitude of the scaling module 1 is determined based on the echo time and echo intensity.

A propagation distance between the laser radar 4 and the scaling module 1 may be determined based on the echo time. The echo intensity depends on the propagation distance on the one hand and an angle of each observation region relative to the laser radar 4, that is, an included angle θ between the normal vector n and the Z axis. When the propagation distance is constant, the echo intensity has a corresponding relationship with θ. Therefore, the θ corresponding to the plurality of observation regions may be obtained based on the echo intensity, and the attitude of the scaling module 1 may be determined.

In step 420, the method for determining the incident angle of the light source includes step 424, step 425 and step 426.

Step 424: determining a second radiance value and an irradiance value corresponding to each observation region on the first image information based on the first image information.

Step 425: determining a length of a normal vector of the plane where the corresponding observation region is located based on the irradiance value.

Step 426: obtaining the incident angle of the light source by combining normal vectors corresponding to the plurality of observation regions.

As shown in FIG. 2, it is known from common sense that when the light irradiates directly on the plane, the irradiance value of the plane is the largest. When the included angle between the light and the plane decreases, the irradiance value of the plane decreases accordingly. Therefore, the irradiation direction of the light source, that is, the incident angle of the light source may be determined by measuring the irradiance values of the plurality of observation regions.

The plane with the largest irradiance value among multiple observation regions may be selected as a datum plane A. As can be seen from the above common sense, it may be roughly estimated that the light source irradiates the datum plane A roughly in a directly facing manner. To facilitate the synthesis calculation of the vector, it is necessary to minimize the number of vectors. Therefore, it only needs to select the plurality of observation regions around the datum plane A, namely B, C, D, E and F. The normal vector corresponding to the observation region A is N1, and the normal vector corresponding to the observation region B is N2, the normal vector corresponding to the observation region C is N3, the normal vector corresponding to the observation region D is N4, the normal vector corresponding to the observation region E is N5, and the normal vector corresponding to the observation region F is N6. As mentioned above, the plurality of observation planes have a certain relative spatial position relationship between each other, and the included angle between the normal vectors between any two observation planes is known. The length of the corresponding normal vector may be determined based on the irradiance value of each observation region and the greater the irradiance value, the greater the normal vector length, and the included angle and length of each normal vector are determined. The vectors N1, N2, N3, N4, N5 and N6 are combined in the three-dimensional space to obtain the vector N and the direction corresponding to N is the opposite direction in which the light source irradiates, and the incident angle of the light source may be determined.

After the attitude of the scaling module and the incident angle of the light source are obtained, the BRDF characteristics of each observation region under the light source environment may be obtained based on the BRDF value corresponding to each observation region.

Step 430: matching the surface of interest with the observation region based on the first radiance value of the surface of interest on the to-be-measured object, and determining the BRDF characteristics of the surface of interest under the light source environment.

In an embodiment, step 430 includes:
obtaining the second radiance value corresponding to each observation region based on the first image information, finding the second radiance value closest to the first radiance value by matching the first radiance value with a plurality of second radiance values, where an observation region corresponding to the second radiance value is the observation region closest to the surface of interest, and determining the BRDF characteristics of the surface of interest under the light source environment based on the BRDF characteristics of the closest observation region under the light source environment.

In the present embodiment, by providing the polyhedral scaling module, the attitude of the scaling module and the incident angle of the light source may be measured from multiple dimensions, which improves both the accuracy of measuring the attitude of the scaling module and the incident angle of the light source and accuracy of measuring the BRDF characteristics of the surface of the to-be-measured object, and improves the precision and accuracy of measurement while avoiding blind spots in the visual field.

It should be noted that the above embodiments are only used to explain the solutions of the present disclosure, and are not limited thereto. Although the present disclosure has been described in detail with reference to the foregoing embodiments, it should be understood by those skilled in the art that modifications to the solutions documented in the foregoing embodiments and equivalent substitutions to a part of the features may be made and these modifications and substitutions do not make the corresponding solutions depart from the scope of the solutions of various embodiments of the present disclosure.

1. A scaling module, comprising:
a plurality of observation planes,
wherein at least two of the plurality of observation planes intersect with each other, the plurality of observation planes have a certain relative space positional relationship, each observation plane is provided with an observation region, and each observation region has a corresponding calibrated bidirectional reflectance distribution function (BRDF) value.

2. The scaling module of claim 1, wherein shapes of the observation region comprise: a regular triangle, a square, a regular pentagon, a regular hexagon, and a regular octagon.

3. The scaling module of claim 1, wherein the observation region is divided into a plurality of standard regions, and the plurality of standard regions at least have two BRDF characteristics.

4. The scaling module of claim 1, wherein the plurality of observation planes enclose a closed cavity.

5. A usage method of the scaling module of claim 1, further comprising:
obtaining first image information of the scaling module and second image information of a to-be-measured object by placing the scaling module in a light source environment where the to-be-measured object is located;
determining an attitude of the scaling module and an incident angle of a light source based on the first image information;
determining a first radiance value of a surface of interest on the to-be-measured object based on the second image information; and
matching the surface of interest with an observation region and determining a BRDF characteristic of the surface of interest under the light source environment based on the first radiance value.

6. The method of claim 5, wherein determining the attitude of the scaling module and the incident angle of the light source based on the first image information comprises:
performing ellipse fitting on each vertex of one of the observation regions on the first image information to obtain a fitted ellipse;
obtaining a center coordinate, a major axis length and a minor axis length of the fitted ellipse; and
determining an orientation of the observation plane corresponding to the fitted ellipse based on the center coordinate, the major axis length, and the minor axis length of the fitted ellipse to obtain the attitude of the scaling module.

7. The method of claim 5, wherein determining the attitude of the scaling module and the incident angle of the light source based on the first image information further comprises:
determining a second radiance value and an irradiance value corresponding to each observation region on the first image information based on the first image information;
determining a length of a normal vector of the observation plane where the corresponding observation region is located based on the irradiance value; and
obtaining the incident angle of the light source by combining normal vectors corresponding to the plurality of observation regions.

8. The method of claim 7, wherein matching the surface of interest with the observation region and determining the BRDF characteristic of the surface of interest under the light source environment based on the first radiance value comprises:
matching the first radiance value with a plurality of the second radiance values to determine an observation region corresponding to the surface of interest; and
determining the BRDF characteristic of the surface of interest under the light source environment based on the BRDF characteristic of the observation region under the light source environment.

9. The method of claim 5, wherein determining the attitude of the scaling module and the incident angle of the light source based on the first image information further comprises:
obtaining an echo time and an echo intensity of each observation region of the scaling module; and
determining the attitude of the scaling module based on the echo time and the echo intensity.
